(19) United States
(12) Patent Application Publication
(10) Pub. No.: US 2026/0054623 A1
(43) Pub. Date: Feb. 26, 2026

(54) SEAT

(71) Applicant: TOYOTA BOSHOKU KABUSHIKI KAISHA, Aichi (JP)

(72) Inventors: Naoki MITSUOKA, Miyoshi-shi, Aichi-ken (JP); Yukinori SUGIURA, Nisshin-shi, Aichi-ken (JP); Kenichi TSUKAMOTO, Okazaki-shi, Aichi-ken (JP)

(73) Assignee: TOYOTA BOSHOKU KABUSHIKI KAISHA, Aichi (JP)

(21) Appl. No.: 19/120,090

(22) PCT Filed: Oct. 12, 2023
(86) PCT No.: PCT/JP2023/037004

§ 371 Date: Apr. 10, 2025

(30) Foreign Application Priority Data
Oct. 18, 2022 (JP) 2022-166732

(51) Int. Cl. B60N 2/64; B60N 2/58

(52) U.S. Cl. CPC B60N 2/64; B60N 2/5825

(57) ABSTRACT

A seat has a cushion body that elastically supports a seater and a back frame that supports the cushion body from a back side of the seat. The cushion body has a main top panel pad that serves as a cushioning portion. A main top panel resin member is provided on a back side of a pad of the main top panel pad, and the main top panel resin member is fixed to the back frame. A secure attachment clip is assembled to the main top panel resin member. The secure attachment clip is placed in a tuck-in groove formed on the back side of the pad of the main top panel pad.

### CROSS-REFERENCE TO RELATED APPLICATIONS

The present application is a 35 U.S. C. § 371 U.S. National Phase entry of, and claims priority to, PCT Application PCT/JP2023/037004 filed Oct. 12, 2023, which claims priority to Japanese Patent Application No. 2022-166732 filed Oct. 18, 2022, which is hereby incorporated herein by reference in its entirety for all purposes.

### BACKGROUND

One aspect of the present disclosure relates to a seat. More particularly, it relates to a seat having a cushion body that elastically supports a seated person and a seat frame that supports the cushion body from a rear side of the seat.

A conventional vehicle seat has a seat cover that covers a seat pad. The seat cover is stretched and tucked into a tuck-in groove formed on a surface of the seat pad and is securely attached to the seat pad. A resin clip is fixed to a bottom of the tuck-in groove for securely attaching a tuck-in portion of the stretched and tucked seat cover.

The clip is fixed in the tuck-in groove by being integral molded into the seat pad. Therefore, when the seat pad is disposed of, the clip must be removed from the seat pad and separated for recycling, making a process cumbersome. Therefore, one aspect of the present disclosure provides a seat with excellent recyclability.

### SUMMARY

A seat according to one aspect of the present disclosure has a cushion body that elastically supports a seater and a seat frame that supports the cushion body from a back side of the seat. The cushion body has a seat pad that serves as a cushioning portion. A supporting member is provided on a back side of the pad, which is a surface of the seat pad on the back side of the seat. The supporting member is fixed to the seat frame. A member arranged inside a pad is assembled to the supporting member, and the member arranged inside a pad is arranged in a recess formed in the back side of the pad of the seat pad.

According to the above configuration, the member arranged inside a pad is not integrally molded into the seat pad. The member arranged inside a pad is fixed to the seat frame via the supporting member and is arranged within the recess formed in the back side of the pad of the seat pad. Therefore, when disposing of the cushion body, the member arranged inside a pad can be easily separated from the seat pad. Overall, the cushion body is designed elastically support a seater while being easily recyclable and maintainable.

According to another aspect of the present disclosure, a tuck-in portion is formed in an intermediate portion of the seat cover covering the seat pad. The recess is a through-shaped tuck-in groove for the tuck-in portion to be stretched and tucked in from the front side of the seat. The member arranged inside a pad has a hook that enters the recess. The tuck-in portion stretched and tucked into the recess of the seat cover is securely attached to the hook.

According to the above configuration, a hook is provided in the member arranged inside a pad which allows the intermediate portion of the seat cover to be stretched and tucked in and securely attached to the seat pad. The member arranged inside a pad may properly perform the secure attachment function without being integrally molded into the seat pad.

According to another aspect of the present disclosure, the supporting member is configured such that the member arranged inside a pad is inserted from the back side of the seat and meets the back side of the member arranged inside a pad.

According to the above configuration, the member arranged inside a pad meets the supporting member from the back side of the seat. Even if the supporting member is subjected to tension due to the seat cover being stretched and tucked in, the member inside the pad becomes less likely to be removed from the supporting member. Therefore, the member arranged inside a pad may be more appropriately held to the supporting member.

According to another aspect of the present disclosure, the cushion body includes three separate elements divided into a main top panel that forms a central portion in a seat width direction and respective side top panels that form two side portions in the seat width direction. The main top panel includes the supporting member and the member arranged inside a pad.

According to the above configuration, the cushion body may be downsized due to separation. The small main top panel includes the supporting member and the member arranged inside a pad. Therefore, the flexibility in molding the main top panel may be increased. Moreover, the member arranged inside a pad is ensured to function properly without being integrally molded into the main top panel.

### BRIEF DESCRIPTION OF DRAWINGS

FIG. 1 is a perspective view illustrating a schematic structure of a seat according to a first embodiment.

FIG. 2 is a front view of a seatback.

FIG. 3 is an exploded perspective view of the seatback with a cushion body removed from a back frame.

FIG. 4 is a front view of the back frame.

FIG. 5 is a rear view of the cushion body.

FIG. 6 is a perspective view illustrating the cushion body assembled to the back frame.

FIG. 7 is a cross-sectional view taken along line VII-VII in FIG. 2.

FIG. 8 is a perspective view illustrating a resin member of an outer side top panel assembled to the side frame.

FIG. 9 is a cross-sectional view taken along line IX-IX in FIG. 2.

### DETAILED DESCRIPTION

Hereinafter, an embodiment for carrying out one aspect of the present disclosure will be described with reference to the drawings.

### First Embodiment

Schematic structure of Seat 1

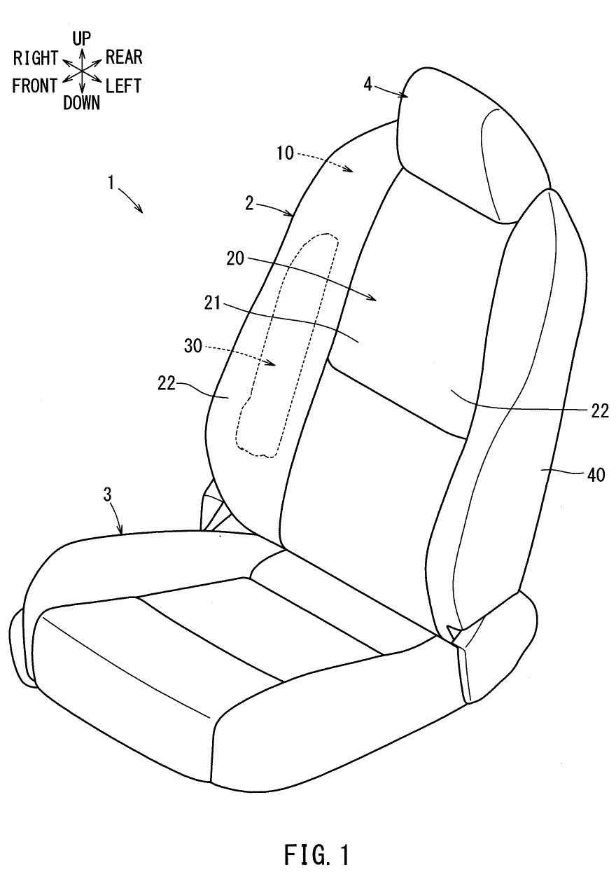

A structure of a seat 1 according to the first embodiment will be described with reference to FIG. 1 through FIG. 9. In the following description, each direction such as front, rear, up, down, left, and right refers to directions indicated in each figure. When “seat” is appended to each direction, such as “seat width direction,” it shall refer to a direction based on an orientation of the seat 1 as will be described below. In the following description, when a specific reference figure is not shown or when corresponding reference numerals are not provided in the reference figure, any one of the figures from FIG. 1 to FIG. 9 shall be referred to as appropriate.

As shown in FIG. 1, the seat 1 according to the present embodiment is configured as a right-side seat for a single person mounted on a floor of an automobile. The seat 1 is provided with a seatback 2 that forms a backrest portion for a seated person, a seat cushion 3 that forms a seating portion, and a headrest 4 that forms a headrest portion.

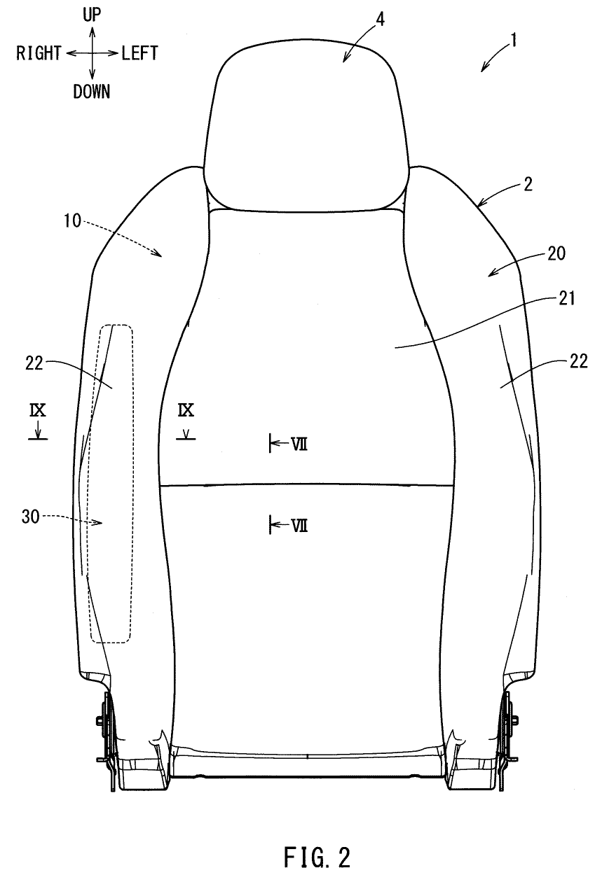

As shown in FIG. 2, the seatback 2 is equipped with a side airbag system 30 on its right side, which is outside of the vehicle width direction. The side airbag system 30 is a well-known device that protects a head and chest of the seated person by causing an airbag 31 to break through the seatback 2 and expand toward a front of the seat when a vehicle collision is detected.

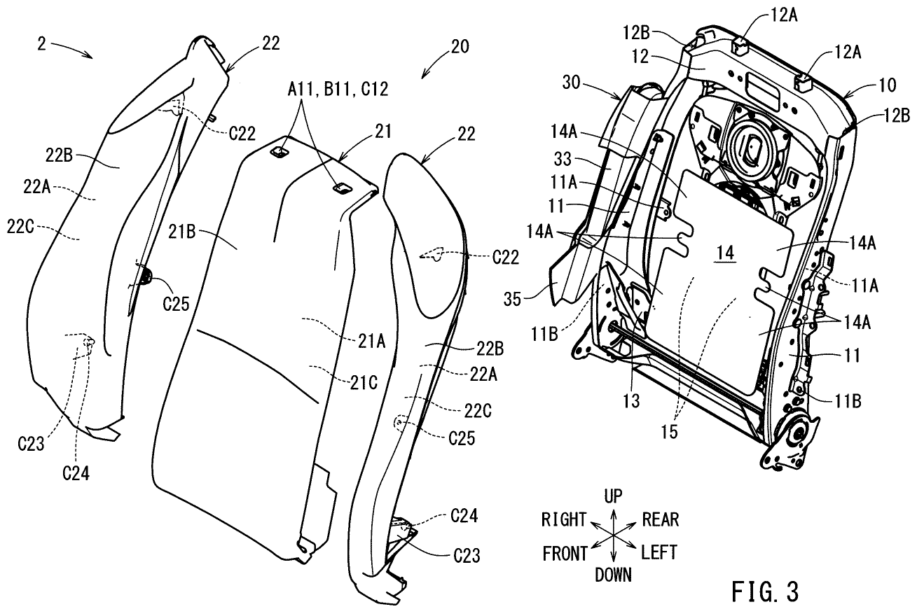

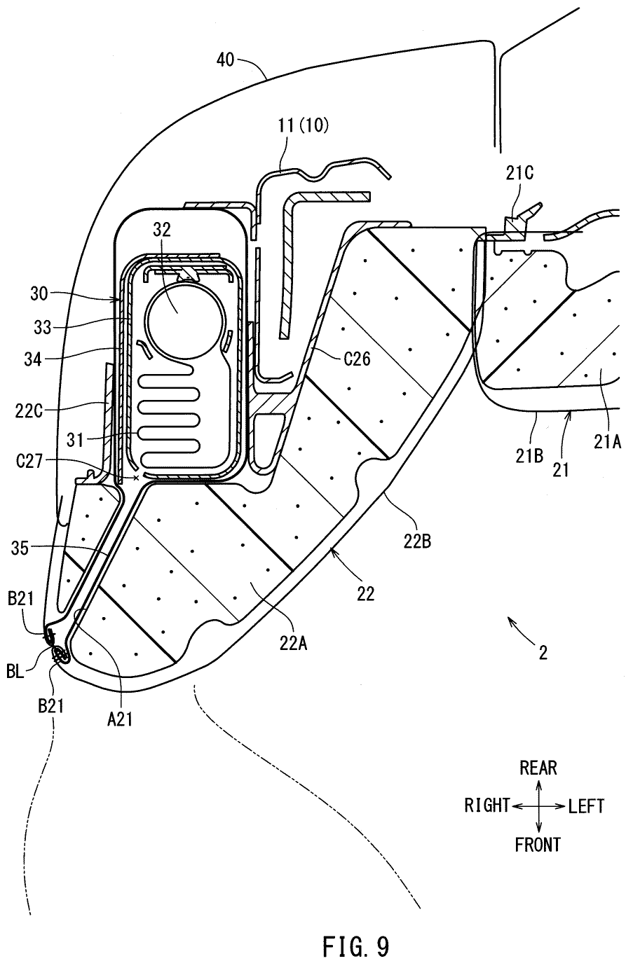

As shown in FIG. 3, the seatback 2 has a metal back frame 10 that forms its framework, and a cushion body 20 that is assembled to a front of the back frame 10 and elastically supports a waist and back of the seated person. The seatback 2 also has a backboard 40 (see FIG. 9) assembled to a rear of the back frame 10 and covering a rear side of the seatback 2. Here, the back frame 10 corresponds to a “seat frame” according to one aspect of the present disclosure.

As shown in FIG. 3, the cushion body 20 includes three separate elements divided into a main top panel 21, which forms a central portion in the seat width direction, and respective side top panels 22, which form two side portions in the seat width direction. The main top panel 21 supports a waist and back of a seated person from a backside.

Each side top panel 22 supports the seated person's waist and back from an outside diagonally rearward. Each side top panel 22 has a front surface that is a front side of the seat, and is formed into a planar shape that rises diagonally forward toward the outside of the seat width direction.

The main top panel 21 and each side top panel 22 are individually assembled to the back frame 10 from the front of the seat, respectively. Therefore, the main top panel 21 and each side top panel 22 may be easily attached to and removed from the back frame 10 without removing the seat 1 mounted on the floor. Specific details will be described later.

### Structure of Seatback 2

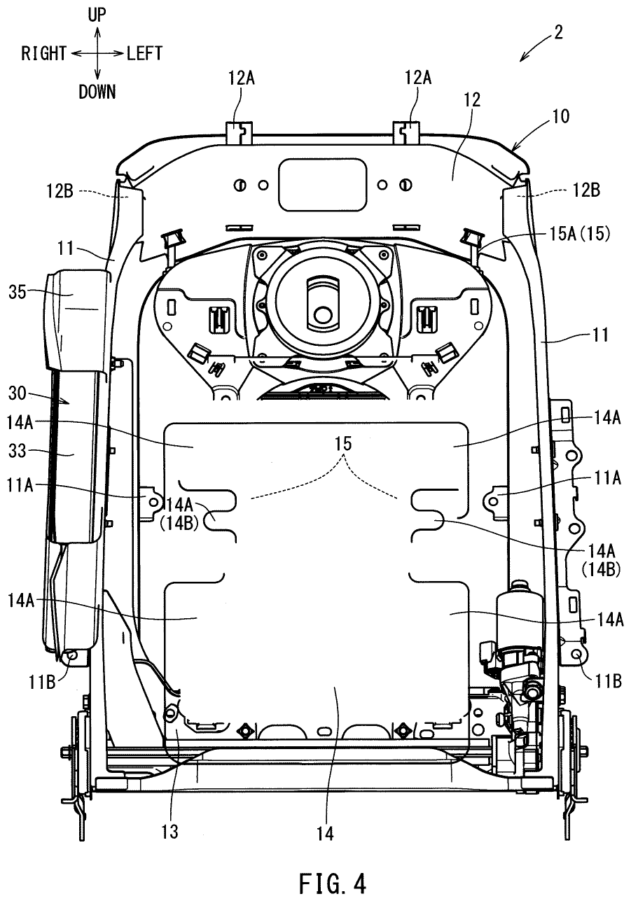

Hereinafter, the specific configuration of each part of the seatback 2 will be described below. As shown in FIG. 3 to FIG. 4, the back frame 10 has a pair of left and right side frames 11 that extend in an up-down direction along both the left-right sides of the seatback 2. Further, the back frame 10 also has an upper frame 12 spanning across between upper ends of each side frame 11, and a lower frame 13 spanning across between lower ends of each side frame 11.

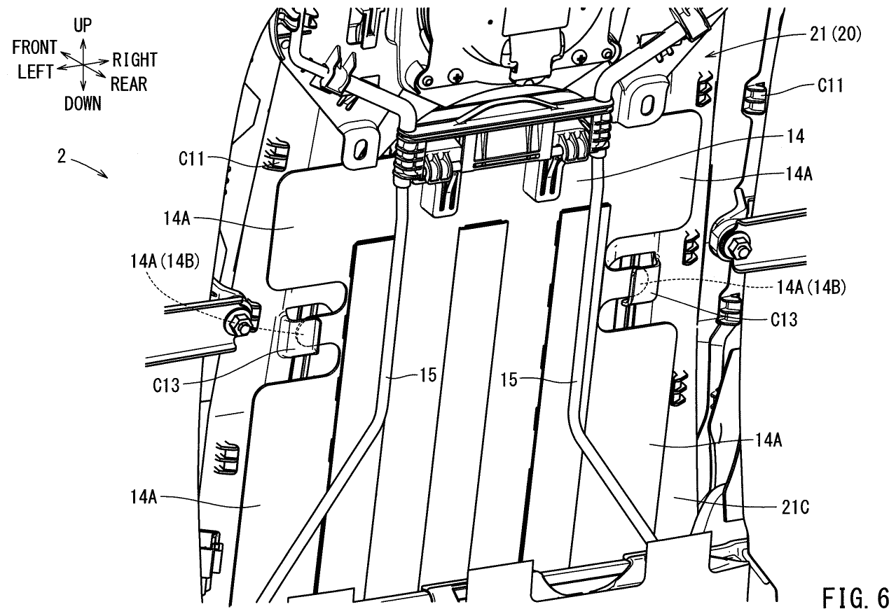

The back frame 10 further has a planar lumbar plate 14. The lumbar plate 14 is hung between the upper frame 12 and the lower frame 13. The lumbar plate 14 is hung between the upper frame 12 and the lower frame 13 via a support spring 15 as shown in FIG. 6. The support spring 15 is bent into a U-shape, which allows it to provide elastic support.

As shown in FIG. 4, both upper ends 15A of the U-shaped support spring 15 are inserted into the upper frame 12 from below the seat. A lower edge of the support spring 15 is elastically supported from a backside the seat at the front of the lower frame 13 via a torsion spring (not shown). The lumbar plate 14 is made of a resin flat plate member elongated in the up-down direction.

Upper and lower ends of the lumbar plate 14 forming a sliding mechanism are assembled to the left and right edges of the support spring 15, allowing the lumbar plate to slide up and down. A drive unit (not shown) is assembled to the back frame 10. The drive unit causes the upper and lower ends of the lumbar plate 14 to move up and down along each edge of the support spring 15.

The lumbar plate 14 is moved such that a distance between its upper end and its lower end approaches, causing an intermediate portion between the upper end and the lower end to bend forming a bowing curve toward the front of the seat. As a result, a support position that is a lower half of the main top panel 21 of the cushion body 20 (support position of the waist) by the lumbar plate 14 is pushed toward the front of the seat. This increases the support pressure exerted by the main top panel 21 on the seated person's waist. Further, the lumbar plate 14 can adjust the support position of the waist in the up-down direction by moving its upper end and its lower end up and down together.

As shown in FIG. 3 and FIG. 4, the left and right portions of the lumbar plate 14 have a planar vertical surface (upper vertical surface and lower vertical surface) that extends in the up-down direction along the left and right edges of the support spring 15. A plurality (e.g., three) of fins 14A are formed on each of the left and right edges of the lumbar plate 14. The fins 14A extend in the left-right direction (outward in the seat width direction) from the left-right edges of each vertical surface. Each fin 14A extends outwardly in the left-right direction from the left and right edges of the support spring 15 to extend the support surface of the lumbar plate 14.

As shown in FIG. 3 and FIG. 4, a plate-like fastening bracket 11A is welded to a rear edge of each side frame 11, extending diagonally rearward toward the inner side in the seat width direction. Each fastening bracket 11A is arranged with an inner diagonally forward-facing front surface (overlapping surface) oriented to an installation space of the main top panel 21. Fastening portions C25 shown in FIG. 3 are fastened to these fastening brackets 11A via a plug-in fastening structure. Each fastening portion C25 extends from a side top panel resin member 22C on a rear side of the seat of each side top panel 22.

As shown in FIG. 4, a bracket having a round hole-shaped engagement hole 11B is connected to an outer side portion on a lower end of each side frame 11. In each engagement hole 11B, a fitting clip C24 is engaged with a snap-fit upon insertion from the front side of the seat. Each fitting clip C24 is attached to the lower part of the side top panel resin member 22C on the rear side of the seat of each side top panel 22.

Support brackets 12A are welded to the upper frame 12 at two left and right locations. The support brackets 12A extend in a square cylindrical shape in the up-down direction and penetrate the upper frame 12 in the up-down direction. Each support bracket 12A penetrates a top panel portion and a bottom panel portion of the upper frame 12 in the up-down direction and is welded to each of the top panel portion and bottom panel portion. An upper end of each support bracket 12A protrudes above the seat from the top panel portion of the upper frame 12.

Each support bracket 12A serves as an attachment portion for the headrest 4 of FIG. 1 to be inserted from above the seat and attached to the upper portion of the seat back 2. In each support bracket 12A, a pair of left and right headrest stays (not shown), hanging down from the headrest 4, are inserted from above the seat, respectively. The pair of left and right headrest stays are provided on a headrest support (not shown) of the headrest 4.

As shown in FIG. 4, each of left and right ends (shoulders) of the upper frame 12 is formed with a bored fitting hole 12B to allow the top panel portion to pass through in the up-down direction, respectively. An upper end fitting portion C22 is fitted into each fitting hole 12B by hooking from above the seat. The upper end fitting portion C22 is formed on an upper portion of the side top panel resin member 22C on the rear side of the seat of each side top panel 22.

### Structure of Main Top Panel 21

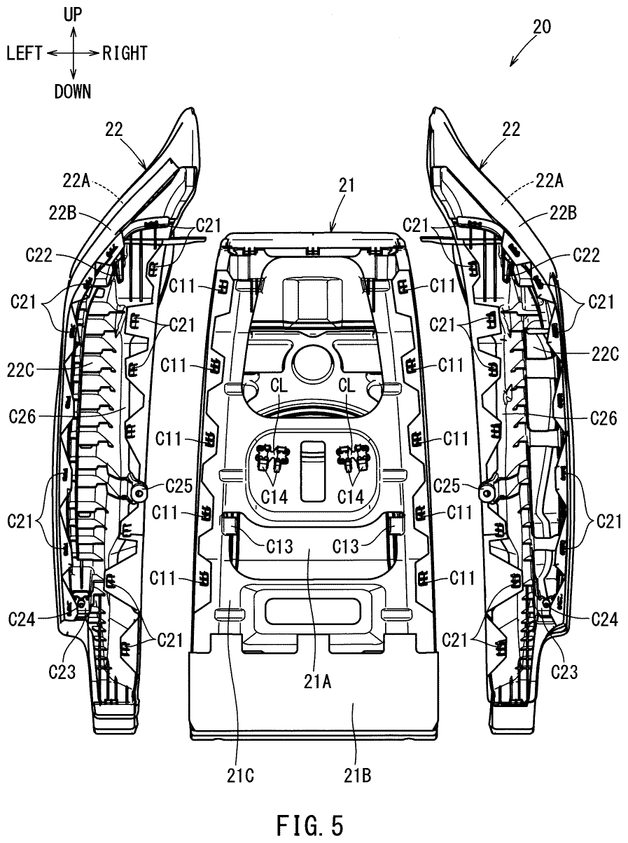

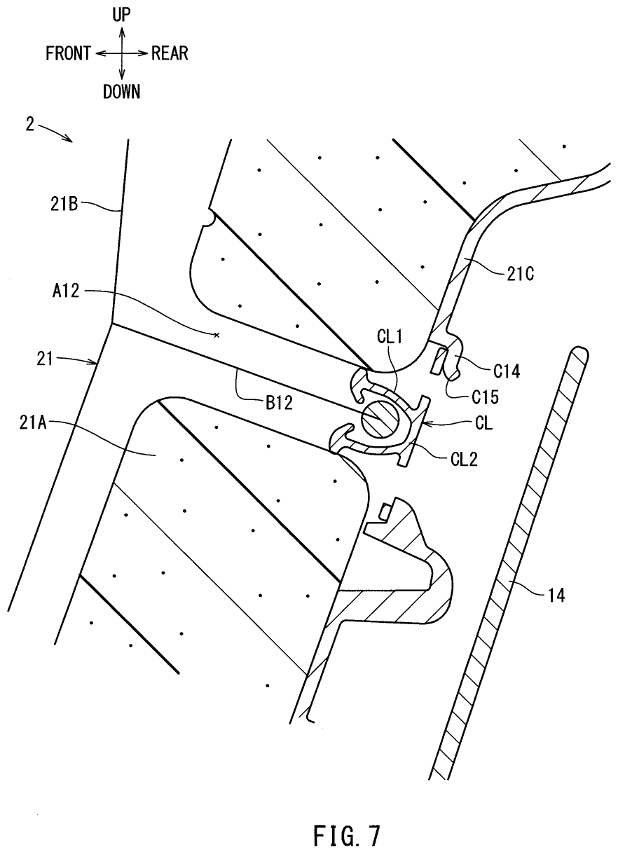

The cushion body 20 is composed of a main top panel 21 and respective side top panels 22. As shown in FIG. 3, FIG. 5 and FIG. 7, the main top panel 21 has a main top panel pad 21A that serves as a cushioning portion. The main top panel pad 21 A is covered by a main top panel cover 21B made of fabric. A main top panel resin member 21C is provided on a rear side of the pad, which is a surface of the main top panel top pad 21 on the rear side of the seat.

The main top panel pad 21A corresponds to a “seat pad” in one aspect of the present disclosure. Further, the main top panel cover 21B corresponds to a “seat cover” in one aspect of the present disclosure. Furthermore, the main top panel resin member 21C corresponds to a “supporting member”in one aspect of the present disclosure.

As shown in FIG. 5 and FIG. 7, the main top panel pad 21 A is made of polyurethane foam molding. As shown in FIG. 3, the main top panel pad 21A is formed to have a mat shape that is covered from the front of the seat on the upper frame 12 and the lumbar plate 14 of the back frame 10. Specifically, the main top panel pad 21A is formed with an eave portion at its upper portion, which is covered over the top panel portion of the upper frame 12 from above the seat.

As shown in FIG. 3, a pair of left and right support through-holes A11 are formed in the eave portion at the upper portion of the main top panel pad 21A. The support through-holes A11 are square holes and penetrate the main top panel pad 21A in the up-down direction. The eave portion of the main top panel pad 21A is covered over the top panel portion of the upper frame 12 via the main top panel resin member 21C that will be described later. At that time, the upper end of each corresponding support bracket 12A is inserted into each support through-hole A11.

As shown in FIG. 3, the main top panel cover 21B is covered over the main top panel pad 21A from the front of the seat. Each of upper, lower, left and right peripheral edges of the main top panel cover 21B is pulled into and securely attached to the rear side of the pad of the main top panel pad 21A. Specifically, as shown in FIG. 5, the main top panel cover 21B has an end of each peripheral edge that is pulled into the rear side of the pad of the main top panel pad 21A. Each end of the main top panel cover 21B is hooked and securely attached to the main top panel resin member 21C in the form of a frame in a rear view provided on the rear side of the pad.

As a result of the above hooking, the main top panel cover 21B is stretched over an entire outer surface of the main top panel pad 21A. Further, the main top panel resin member 21C is secured while being pressed against the rear side of the pad of the main top panel pad 21A through the hooking of each end of the main top panel cover 21B. The main top panel cover 21B has an eave area that covers the eave portion of the main top panel pad 21A. In the eave area, each support through-hole B11 is formed to communicate each support through-hole A11 to the outside. Each support through-hole B11 has a square hole shape and communicates with the eave area of the main top panel resin member 21C in the up-down direction.

As shown in FIG. 7, the mail top panel cover 21B includes a tuck-in portion B12 that is inserted into a tuck-in groove A12. The tuck-in portion B12 may be formed, for example, in an intermediate portion in an area of the main top panel cover 21B in the up-down direction that covers the front side of the main top panel pad 21A. The tuck-in portion B12 is tucked in the tuck-in groove A12 from the front of the seat and is securely attached therein. The tuck-in portion B12 is located on the rear side of the cover in the intermediate portion of the main top panel cover 21B. The tuck-in portion B12 includes a tubular hanging cotton cloth that is sewn along the intermediate portion to extend in the seat width direction, and a hanging wire that is threaded along the hanging cotton cloth.

As shown in FIG. 7, the tuck-in groove A12 is formed in the main top panel pad 21A, penetrating in the pad thickness direction (in the front-rear direction of the seat). The tuck-in portion B12 is pulled into the tuck-in groove A12 from the front of the seat. The tuck-in portion B12 is then hooked and securely attached to the main top panel resin member 21C on the rear side of the pad. Four secure attachment clips CL are formed at the main top panel resin member 21C, which are attached to a clip locking portion C14 and are aligned in the seat width direction. A tuck-in portion B12 is hooked to each hook CL1 of the secure attachment clips CL. Thereby, an intermediate portion of the main top panel cover 21B is closely fitted along an outer surface of the main top panel pad 21A, and the main top panel cover 21B is stretched and fitted.

As shown in FIG. 7, the secure attachment clip CL consists of an injection molded product of resin having a hook CL1 and a seat CL2. The tuck-in portion B12 is hooked to the hook CL1. The seat CL2 is attached to the main top panel resin member 21C. Specifically, the secure attachment clip CL is set on the main top panel resin member 21C from a backside the seat. The hook CL1 of the secure attachment clip CL is thus inserted into each hole C15 formed in the main top panel resin member 21C. The clip locking portion C14 (elastic claw) formed around each hole C15 is pushed from a backside against the seat CL2 and elastically deformed. The seat CL2 is pushed over the clip locking portion C14, and the clip locking portion C14 is snap-fitted on the rear side of the seat CL2.

As shown in FIG. 7, the seat CL 2 is pressed and held between the rear side of the main top panel resin member 21C and the clip locking portion C14 in the front-rear direction. The hook CL1 of each secure attachment clip CL protrudes from the main top panel resin member 21C toward the front of the seat and enters the tuck-in groove A12 of the main top panel pad 21A.

The secure attachment clip CL and tuck-in portion B12 are, for example, of a known structure. The tuck-in groove A12 corresponds to a “recess” in one aspect of the present disclosure. The secure attachment clip CL corresponds to a “member arranged inside a pad”and a “clip”in one aspect of the present disclosure.

As shown in FIG. 5, the main top panel resin member 21C is an injection molded product and may have, for example, a shape in the form of a frame in rear view extending along an outer peripheral edge of the rear side of the pad of the main top panel pad 21A. Cover hooking claws C11 are formed at each of the left, right, and upper edges of the main top panel resin member 21C. Each end of the main top panel cover 21B is securely attached to each cover hooking claw C11. As a result, the main top panel resin member 21C is integrally fixed to the rear side of the main top panel pad 21A via the main top panel cover 21B.

As shown in FIG. 3, the main top panel resin member 21C has an eave area that overlaps the rear side of the pad at the eave portion of the main top panel pad 21A. Support through-holes C12 are formed in the eave area penetrating in the up-down direction. Each support through-hole C12 has a square hole shape and allows each support through-hole A11 of the main top panel pad 21A to communicate with the lower part of the seat.

As shown in FIG. 3, the main top panel 21 is assembled to the back frame 10 from above the seat as follows. First, the eave portion at the top of the main top panel 21 that extends rearward the seat is placed over the upper frame 12. At that time, each support through-hole C12 of the main top panel resin member 21C is passed through with the corresponding upper end of each support bracket 12A on the upper frame 12. The eave portion of the main top panel 21 is thus hooked onto the upper end of each support bracket 12A and secured in position.

Next, using the hooked eave portions as a fulcrum, the main top panel 21 is lowered onto the lumbar plate 14 so that it is covered from the front of the seat. As shown in FIG. 6, the lumbar plate 14 has three left fins 14A that extend to the left and three right fins 14A that extend to the right. The left fin 14A in the middle of the up-down direction and the right fin 14A (hooking portion 14B) in the middle of the up-down direction are hooked to the front sides of the left and right hooked portions C13 of the main top panel resin member 21C. The hooked portions C13 extend inward from the inner edge of each of the left and right frame sides of the main top panel resin member 21C.

The upper left and upper right fins 14A are located on the upper side of the hooked portion C13 and are pressed against the rear side of each of the left and right frame sides of the main top panel resin member 21C. The lower left and lower right fins 14A are located on the lower side of the hooked portion C13 and are pressed against the rear side of each of the left and right frame sides of the main top panel resin member 21C. As a result, with these fins 14A, each frame side of the main top panel resin member 21C is pressed and held in the front-rear direction.

As shown in FIG. 5, the lower part of the main top panel 21 is provided with a main top panel cover 21B that extends below the seat. The end of the main top panel cover 21B is pulled through the underside of the lower frame 13 (see FIG. 4) of the back frame 10 to the rear of the seat and is securely attached to the rear side of the lower frame 13. With the above assembly, the upper portion, the lower portion and the intermediate portion of the main top panel 21 are engaged with the back frame 10 or the lumbar plate 14, respectively.

The lumbar plate 14 is bent to form a bowing curve to the front of the seat or to return the curve to the rear of the seat. The main top panel 21 is moved in the front-rear direction of the seat following this movement of the lumbar plate 14. When the position of the lumbar plate 14 is adjusted in the up-down direction, each fin 14A slides up and down along the main top panel resin member 21C.

structure of Each Side Top Panel 22

Hereinafter, the configuration of each side top panel 22 will be described with reference to FIG. 3, FIG. 5 and FIG. 9. Each side top panel 22 has a side top panel pad 22A that serves as a cushioning portion, a side top panel cover 22B made of fabric that covers the side top panel pad 22A, and a side top panel resin member 22C that is provided on the rear side of the pad of the side top panel pad 22A. While each side top panel 22 is configured to have substantially the same basic structure as each other, a side airbag system 30 is provided on the right side of the seatback 2. Therefore, the right side top panel 22 is provided with a path for deploying an airbag 31 and an installation space for the side airbag system 30 is ensured in the right side top panel 22.

As shown in FIG. 9, the side top panel pad 22A is made of polyurethane foam molding. The side top panel pad 22A has a pad surface on its front side of the seat. The pad surface rises from the inside in the seat width direction outwardly to expand diagonally toward the front of the seat. In other words, the side top panel pad 22A is formed in a shape having a bank-like extension.

The rear side of the pad of the side top panel pad 22A is formed in the shape of a depressed curved surface, which is hollowed out to be depressed along the above bank-like extension. As shown in FIG. 3 and FIG. 5, the upper portion of the side top panel pad 22A is formed with an eave portion that is placed on the top panel portion of the upper frame 12 from above the seat.

The side top panel cover 22B is covered over the side top panel pad 22A from the front of the seat. Each of the upper, lower, left and right peripheral edges of the side top panel cover 22B is pulled into and securely attached to the rear side of the pad of the side top panel pad 22A. Specifically, each of the left and right ends of the side top panel cover 22B is hooked and securely attached to a side top panel resin member 22C in the form of a curved plate provided along the rear side of the pad.

As a result of the above hooking, the side top panel cover 22B is stretched over the entire outer surface of the side top panel pad 22A. Further, the side top panel resin member 22C is secured to the rear side of the side top panel pad 22A while being pressed against the rear side of the pad through the hooking of each end of the side top panel cover 22B.

As shown in FIG. 5 and FIG. 9, the side top panel resin member 22C is made of an injection molded product molded in a shape that conforms to the depressed curved surface of the rear side of the pad of the side top panel pad 22A. The side top panel resin member 22C has a side support portion C26. The side support portion C26 supports the bank-like extension of the side top panel pad 22A at an angle along the extension from the rear side of the pad. As a result, a side of a body of the seated person is properly supported by the side top panel pad 22A.

As shown in FIG. 5, cover hooking claws C21 are formed at a peripheral edge of the side top panel resin member 22C. Each end of the side top panel cover 22B, which is pulled into the rear side of the pad, is securely attached to the cover hooking claw C21. The side top panel resin member 22C has an eave area that overlaps the rear side of the pad of the eave portion of the side top panel pad 22A. In the eave area, an upper end fitting portion C22 is formed to protrude below the seat.

The upper end fitting portion C22 of each side top panel 22 is inserted into the corresponding fitting hole 12B formed at each of the left and right ends (shoulder) of the upper frame 12 when the side top panel 22 is assembled to the back frame 10 (see FIG. 3). With the above insertion, the upper part of the side top panel 22 is hooked onto the upper frame 12 and secured in position.

As shown in FIG. 5, a pedestal portion C23 protruding rearward the seat is formed at the lower part of the side top panel resin member 22C. A fitting clip C24 is attached to an end of the pedestal portion C23. An engagement hole 11B, for example in the form of a round hole, is formed in the rear edge of the lower end of each side frame 11. When the side top panel 22 is assembled to the back frame 10 (see FIG. 3), the fitting clips C24 are snap-fitted into the engagement holes 11B. The lower part of each side top panel 22 is snap-fitted by fitting clips C24 into engagement holes 11B in the lower end of each side frame 11.

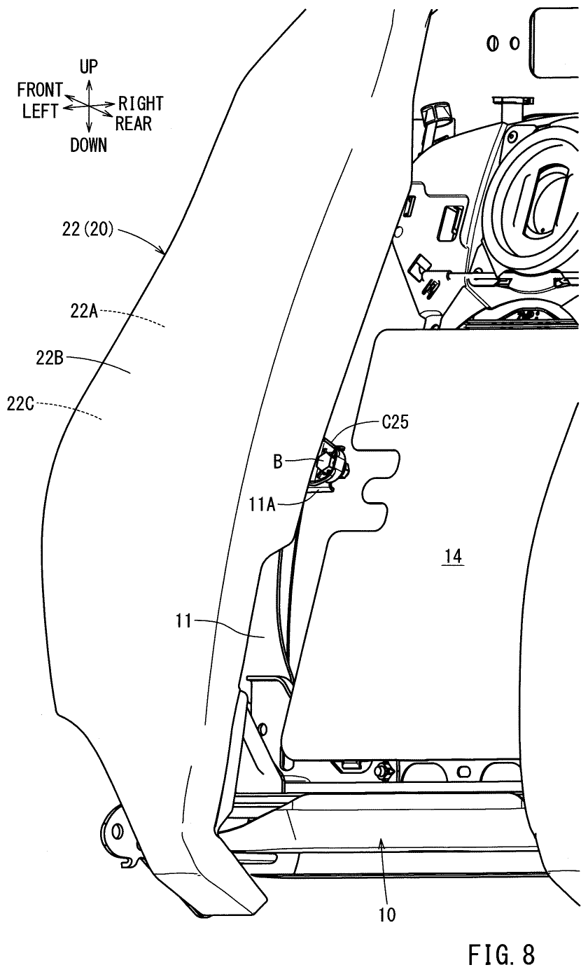

As shown in FIG. 5, a fastening portion C25 is formed in the intermediate portion of the side top panel resin member 22C in the up-down direction. As shown in FIG. 8, the fastening portion C25 is plate-shaped and extends diagonally rearward from the inside edge of the seat width direction of the side top panel resin member 22C toward the inner side in the seat width direction. As shown in FIG. 4, each side frame 11 has a fastening bracket 11A extending rearward diagonally inward from the inner peripheral edge. The front side of the fastening bracket 11A is oriented diagonally forward. By assembling the side top panel 22 to the back frame 10, the fastening portion C25 is overlapped on the front side of the fastening bracket 11A (see FIG. 8).

A bolt B having a plug-in type fastening structure, is then inserted into and fastened to the fastening portion C25 and the fastening bracket 11A using a fastening tool (impact tool) (not shown). The fastening portion C25 is thus fastened to the upper side of the fastening bracket 11A in an overlapping manner.

structure of Side Airbag System 30

As shown in FIG. 9, the side airbag system 30 is mounted on the right side (outer side) of the right (outer side of the vehicle width direction) side frame 11. The side airbag system 30 is formed in a longitudinal box shape that extends in an up-down direction along the right side frame 11 in an elongated manner (see FIG. 4).

Specifically, the side airbag system 30 has an airbag 31, an inflator 32, a case 33, a guide plate 34, and a stay cloth 35. The side airbag system 30 receives an input of a detection signal for a vehicle collision from a ECU (not shown) of a vehicle. Upon receiving the detection signal, gas is injected from the inflator 32 into the airbag 31 to inflate and deploy the airbag 31 in front of the seat. The airbag 31 breaks through the seatback 2 over a wide area of the seatback 2 in the up-down direction and is inflated and deployed to form a longitudinal bag shape toward the front of the seat.

The case 33 is a longitudinal, box-shaped case that houses the airbag 31 and inflator 32 inside. Two upper and lower sections of the inside of the case 33 are bolted and secured to the right side of the right side frame 11. A longitudinal slit is formed in the right front side corner of the case 33. When the airbag 31 is inflated and deployed, the deployment pressure pushes open the right front side corner of the case 33. As a result, the airbag 31 is inflated and deployed from the case 33 toward the front of the seat.

As shown in FIG. 9, the case 33 is disposed behind the side top panel resin member 22C. Therefore, an opening C27 is formed in the side top panel resin member 22C to ensure a deployment path for the airbag 31 expanded from the case 33. The opening C27 has a longitudinally rectangular shape to ensure that the substantially entire area directly opposite to the case 33 is open.

As shown in FIG. 9, the guide plate 34 is formed of a longitudinal plate-like member made of metal having an L-shaped cross-section. The guide plate 34 is fixed to the rear side of the case 33 and covers the right side of the case 33. The guide plate 34 extends from the right side of the case 33 through the opening C27 in the side top panel resin member 22C toward the front of the seat. The guide plate 34 covers an edge of the opening C27 from an inside of the seat. The guide plate 34 thus prevents the airbag 31 from directly contacting the edge of the opening C27 when the airbag 31 is inflated and deployed.

As shown in FIG. 9, the stay cloth 35 is configured as a longitudinal guide cloth that guides the deployment direction of the airbag 31. The stay cloth 35 is made from a single piece of fabric member. The stay cloth 35 wraps the case 33 from rear of the seat. Each end of the stay cloth 35 passes through the slit A21 in the side top panel pad 22A from the opening C27. Each end of the stay cloth 35 is sewn to a sewn end B21 of each cover piece. The deployment pressure of the airbag 31 in the side top panel cover 22B breaks the stitching between each end of the stay cloth 35 and the sewn end B21.

As shown in FIG. 9, when the airbag 31 inflates and deploys, the airbag 31 expands from the opening C27 toward the front of the seat. The airbag 31 then passes through the slit A21 formed in the side top panel pad 22A. The slit A21 is directly opposite the case 33 and extends over the substantially entire area of the case 33 in the up-down direction in an elongated manner.

The airbag 31 expands upon receiving gas injection from the inflator 32. The airbag 31 pushes the case 33 to open and passes through the opening C27 in the side top panel resin member 22C. Furthermore, the airbag 31 pushes the slit A21 of the side top panel pad 22A to expand from the rear side of the pad. This breaks the stitching at each of the sewn ends B21 that forms a burst line BL for the side top panel cover 22B, which is sewn to each end of the stay cloth 35. As a result, the airbag 31 is inflated and deployed toward the front of the seat.

### Method for Assembling Seat Back 2

As shown in FIG. 3, each side top panel 22 is assembled to the back frame 10 prior to the main top panel 21 (side top panel assembly process). The assembly method of each side top panel 22 to the back frame 10 is as described above.

After assembling each side top panel 22, the main top panel 21 is assembled to the back frame 10 (main top panel assembly process). The above procedure ensures simple and proper assembly of the cushion body 20, consisting of three separate elements, to the back frame 10. The procedure for removing the cushion body 20 from the back frame 10 is the reverse of the procedure described above.

In summary, the seat 1 according to the present embodiment has the following configuration. In the following, reference numerals in parentheses are the reference numerals corresponding to the respective configurations as described in the above embodiments.

In other words, as shown in FIG. 3, the seat (1) has a cushion body (20) that elastically supports a seated person and a seat frame (10) that supports the cushion body (20) from the rear side of the seat. The cushion body (20) has a seat pad (21A) that serves as a cushioning portion, a supporting member (21C), and a member arranged inside a pad (CL). The supporting member (21C) is provided on a back side of the pad on a back side of the seat of the seat pad (21A) and is fixed to the seat frame (10). The member arranged inside a pad (CL) is assembled to the supporting member (21C) and arranged in a recess (A12) formed in a back side of the pad of the seat pad (21A). The supporting member (21C) has a structure that allows the member arranged inside a pad (CL), such as a secure attachment clip, to penetrate from the back side of the seat and meet the back side of the member arranged inside a pad. This configuration helps in securely attaching the seat cover to the seat pad without a need for integral molding.

According to the above configuration, the member arranged inside a pad (CL) can be fixed to the seat frame (10) via the supporting member (21C) without being integrally molded into the seat pad (21A). In this state, the member arranged inside a pad (CL) can be arranged in the recess (A12) formed on the back side of the pad of the seat pad (21A). Therefore, when the cushion body (20) is disposed of, the member arranged inside a pad (CL) can be easily separated from the seat pad (21A). This allows the seat (1) to be configured for excellent recyclability.

As shown in FIG. 7, the recess (A12) is a through-shaped tuck-in groove (A12). A tuck-in portion (B12) formed in an intermediate portion of the seat cover (21B) covering the seat pad (21A) is stretched and tucked into the tuck-in groove (A12) from the front side of the seat. The member arranged inside a pad (CL) is a clip (CL) having a hook (CL1) that enters the recess (A12). The tuck-in portion (B12) stretched and tucked into the recess (A12) of the seat cover (21B) is securely attached to the clip (CL).

According to the above configuration, the intermediate portion of the seat cover (21B) is stretched and tucked into the seat pad (21A) and securely attached to the clip (CL). The clip (CL) may properly perform the secure attachment function without being integrally molded into the seat pad (21A).

As shown in FIG. 7, the supporting member (21C) is provided with a structure that allows the member arranged inside a pad (CL) to penetrate from the back side of the seat and meets the back side of the member arranged inside a pad (CL). According to the above configuration, the member arranged inside a pad (CL) meets the supporting member (21C) from the rear side of the seat. Therefore, the member arranged inside a pad (CL) becomes less likely to be removed from the supporting member (21C) even when the supporting member (21C) is subjected to tension due to the seat cover (21B) being stretched and tucked in. Thus, the member arranged inside a pad (CL) may be more appropriately held to the supporting member (21C).

As shown in FIG. 3, the cushion body (20) includes three separate elements divided into the main top panel (21) that forms the central portion in the seat width direction and respective side top panels (22) that form two side portions in the seat width direction. The main top panel (21) includes the supporting member (21C) and the member arranged inside a pad (CL).

According to the above configuration, the cushion body (20) may be downsized due to separation. The small main top panel (21) includes the supporting member (21C) and the member arranged inside a pad (CL). Therefore, the flexibility in molding the main top panel (21) may be increased. Moreover, the member arranged inside a pad (CL) is ensured to function properly without being integrally molded into the main top panel (21).

### Other Embodiments

While an embodiment according to one aspect of the present disclosure has been described with reference to a single embodiment, one aspect of the present disclosure may be implemented in various other forms other than the above described embodiments.

The seat in one aspect of the present disclosure may be applied to other vehicles than automobiles such as, for example, trains. Alternatively, the seat may be mounted in vehicles other than automobiles, such as an aircraft and ship. Further, in the above embodiment, the configuration according to one aspect of the present disclosure is applied to a seatback. Alternatively, the above-described configuration may be applied to a seat cushion, an ottoman or a headrest. The cushion body can consist of multiple separate elements, such as a main top panel and side top panels. These elements are individually assembled to the back frame, allowing for easy attachment and removal. Alternatively, the cushion body may consist of a structure divided into two, four or more, or a single undivided structure.

The supporting member provided on the back side of the pad of the seat pad and fixed to the seat frame may be made of resin or may be made of metal. The supporting member may be fixed to the seat pad or may be made of a frame material fixed to the seat frame.

The above-described member arranged inside a pad is assembled to the supporting member and placed in the recess of the seat pad. The member arranged inside a pad serves as a clip for the tuck-in portion of the seat cover to be stretched and tucked in. Alternatively, the member arranged inside a pad may be a bead foam molding such as polypropylene foam or chip urethane, which is provided to partially increase the rigidity of the seat pad. The member arranged inside a pad may be a duct for air distribution connected to a recess in the seat pad. Furthermore, the recess formed in the back side of the pad of the seat pad is a tuck-in groove as described in the above embodiments. Alternatively, the recess does not have to be a hole penetrating in the pad thickness direction, but may be formed as a depression in the back side of the pad.

The main top panel cover and the side top panel cover may be fabric or made of leather material, respectively.

1. A seat comprising:
a seat frame; and
a cushion body supported by the seat frame from a backside and configured to elastically support a seater, wherein the cushion body includes
a seat pad formed with a recess on a back side,
a supporting member provided on the back side of the seat pad and fixed to the seat frame, and
a member arranged inside a pad, assembled to the supporting member, and disposed in the recess of the seat pad.

2. The seat according to claim 1 further comprising:
a seat cover for covering the seat pad, and
a tuck-in portion formed in an intermediate portion of the seat cover,
wherein the recess has a through shape into which the tuck-in portion is stretched and tucked in from a front side of the seat, and
the member arranged inside a pad includes a hook to which the tuck-in portion stretched and tucked in the recess is securely attached.

3. The seat according to claim 2, wherein the member arranged inside a pad is configured with the supporting member inserted from a back side of the seat and to meet the supporting member from the back side of the seat.

4. The seat according to claim 1, wherein the cushion body is divided into three elements consisting of a main top panel that forms a central portion in a seat width direction and respective side top panels that form two side portions in the seat width direction,
wherein the main top panel includes the supporting member and the member arranged inside a pad.

5. The seat according to claim 1, wherein the seat frame is configured to support the body cushion from a backside.

6. The seat according to claim 1, wherein the seat frame further comprises of a pair of left and right side frames, an upper frame, a lower frame, a lumbar plate, a plurality of support brackets, and plurality of fastening brackets.

7. The seat according to claim 6, wherein the lumbar plate comprises a resin flat plate member elongated in an up-down direction, a U-shaped support spring configured to elastically support the lumbar plate, an upper end and a lower end that are assembled to a left and right side edges of the support spring, and a plurality of fins that extend outward for increasing a support surface area.

8. The seat according to claim 6, wherein the lumbar plate further comprises a sliding mechanism including an upper end and a lower end of the lumbar plate that are assembled to a left and right edges of the support spring, and wherein the sliding mechanism is configured to allow the lumbar plate to be slidable in an up-down direction.

9. The seat according to claim 6, wherein the pair of left and right side frames extends in an up-down direction along both sides of the seat.

10. The seat according to claim 6, wherein lumbar plate is disposed between the upper frame and the lower frame providing support to a lower back of the seater.

11. The seat according to claim 6 further comprises a seatback formed a backrest for the seater and configured to support waist and back elastically through the cushion body.

12. The seat according to claim 4, wherein the main member includes a main pad, a main cover, and a main resin member.

13. A seat comprising:
a seat frame; and
a cushion body supported by the seat frame from a back side and configured to elastically support a seater, wherein the cushion body includes
a seat pad formed with a recess on a back side,
a supporting member,
a member arranged inside a pad, assembled to the supporting member, and disposed in the recess of the seat pad,
a seat cover configured to cover the seat pad,
a tuck-in portion formed in an intermediate portion of the seat cover, wherein the tuck-in portion is stretched and tucked into the recess from a front side of the seat, and
a hook positioned in the member arranged inside a pad to which the tuck-in portion is securely attached.

14. The seat according to claim 13, wherein the supporting member is configured to allow the member arranged inside a pad to penetrate from a back side of the seat and meet a back side of the member arranged inside a pad for securely attaching the seat cover to the seat pad without a need for integral molding.

15. The seat according to claim 13, wherein the supporting member is provided on the back side of the seat pad and is fixed to the seat frame for maintaining a structural integrity of the seat.

16. The seat according to claim 13, wherein the cushion body further comprises a main top panel and a plurality side top panels that are individually assembled to a back frame for facilitating attachment and removal.
